(19) United States
(12) Patent Application Publication
(10) Pub. No.: US 2022/0058567 A1
(43) Pub. Date: Feb. 24, 2022

(54) NETWORK COMMUNICATIONS FOR ACCOMMODATING DIGITAL NEWS MANAGEMENT

(71) Applicants: MICHAEL S. ROSENBLUM, NEW YORK, NY (US); LISA E. LAMBDEN, NEW YORK, NY (US)

(72) Inventors: MICHAEL S. ROSENBLUM, NEW YORK, NY (US); LISA E. LAMBDEN, NEW YORK, NY (US)

(21) Appl. No.: 16/998,448

(22) Filed: Aug. 20, 2020

(51) Int. Cl. G06Q 10/06; H04W 4/029

(52) U.S. Cl. CPC G06Q 10/063118; H04W 88/02; H04W 4/029

(57) ABSTRACT

An improved communication system for managing television news production, allowing for complete control of content from the initial pitch of each story idea through assignment, reporting, shooting, editing and final delivery and air of product and programming. Users are able to organize, standardize and maintain complete control over the entire process of newsgathering, production and most importantly, early and often editorial intervention, resulting in vastly increased efficiency of operation as well as substantial cost savings. The system may be applied to conventional television newsrooms but is most applicable when used in conjunction with a smartphone-equipped approach.

### TECHNICAL FIELD

The present disclosure generally relates to improved computerized network communication systems, and in particular relates to managing content, data and information that eliminates the need for paper records and text as has been historically required in fields such as journalism and television news.

### BACKGROUND

When television (TV) was invented in 1939, it did not come with an instruction manual. God did not descend upon Rockefeller Center and tell David Sarnoff ‘thou must have an anchorman. Thou must have a crew.’ The television medium, and news in particular, evolved as a function of what the technology of the 1950's allowed, when television and television news first took off.

In those days, TV cameras were big, heavy, expensive and complicated to operate. They thus required an operator at great expense, and therefore a station typically could only afford a very few. Edit suites were equally large, expensive and complicated, and could only be housed in the station's premises. Thus, a workflow and an architecture for television news evolved that was based on the best that the very expensive, complex and limited technology of the time could allow. That architecture of operating in the 1950s was essentially cast in stone, and it became a kind of industry gospel that lasts to the present day. So even though the technology continued to improve, as cameras got better, smaller, cheaper and easier to operate (culminating in the smartphones, such as the IPHONE), as edits followed suit (culminating in laptop software that is both cheap and simple to use), the ‘way of working’ in TV news never changed.

The flow of content in TV news, from initial idea or story ‘pitch’, through the assignment process to field reporting and production to writing, editing and ultimately air is today little different than it predominantly was in the 1960s. Conventional television stations and networks have, for many years, simply taken each successive new generation of increasingly better technologies with their enormous potential, and plugged them into a very old way of working. They can still get the product on the air, but they fail to leverage off of more than 95% of what these new technologies could do. This results in many inefficiencies.

The conventional television newsroom is done on a piecework basis. An assignment desk starts in the morning, reviews the local newspapers, press releases and wire services, along with their police scanner for local TV news, and then, based on that, assigns the reporters specific stories, derived from those very limited sources of content and information. The reporter is then paired with a video photographer and the two of them head out in a company car to the story location, where they will have an hour or so to gather all the video material they believe they will need to cut the ‘package’, namely the video report that will air that night.

Shooting at a 20:1 ratio (meaning that 95% of the raw material will never be used) the crew then returns to the office where the reporter then screens and logs the material, writes a script, tracks the script and then turns the raw material with the written script over to an editor who then cuts the package together, more often than not, just in time to make air. It is a remarkably stressful, disorganized, randomized and messy system, and it yet is employed daily by TV stations and network not just in the United States but worldwide.

The problem begins with the assignment process. The assignment process encompasses the editorial decisions as to what stories will be covered and how the station or network will allocate their reporting assets is the very foundation of all else that follows. Make good assignments and good stories will follow. Make bad assignments and the content will not attract viewers. All decisions as to what stories are going to be covered are generally decided by one person, called, generically, the assignment desk, as previously mentioned. Because of the cost and complexity of the equipment, there were generally not very many cameras or edits, and thus not many reporters available to assign to cover a city—generally no more than seven or eight. As there was a ‘news hole’, that is, a certain number of stories that had to air each night, each story assigned to each reporter and crew had to work out every day. Thus, there was no opportunity for taking a risk that a story might not work out. So, all of the assignments were inherently safe. By taking stories from the local newspaper, i.e., stories that had already been reported, or using press releases or police scanner radios for fires and such, there was a built-in guarantee that 100% of the assignments would make air. But it also removed the element of risk, which is in many ways, the basis of good journalism. With that element gone, this made for safe, yet predictable programming, night after night, such as a fire, a car crash, or a press conference.

The assignment becomes the DNA of the process, and all that follows is thus an inevitable consequence of the flawed assignment process. Reporting becomes both ad hoc and rushed, meaning that there are almost no opportunities for editorial correction, as one finds in a daily newspaper, and no opportunities for quality control in the process as it happens. The result is more often than not, a rushed, disjointed and mediocre product, night after night, and an expensive one to produce as well.

Because the production process, which is in fact a kind of manufacturing process (in that the stories that air are being produced and then are disposed of) is so uncontrolled and unfocused from its very inception, the industry standard for shooting ratios, namely, the amount of raw video that is shot to produce each minute that makes air, is 20:1. That is, 20 minutes of raw video is shot to produce each one minute that ultimately makes air, after screening, logging, scripting and editing. Thus, every night, 95% of the raw footage and material is never used and simply discarded. This is, to say the least, extremely cost ineffective.

If one were running a restaurant and threw away 95% of the food they purchased nightly to put 5% on the plate for the customer, that restaurant would soon be out of business. Yet that is how TV news has worked for years. As well, the vast overages in shooting means that an inordinate amount of time is spent not just in the acquisition of raw material, but this overage then infects the entire production process, meaning that vast amounts of time are wasted in screening the material once it is brought back, often transcribing it and editing it. As a basic manufacturing process, television news is rife with waste at every step in the process.

Because the production process has been so unwieldy since its inception, the only way to quantify and process video content was to essentially convert it into text, such as written log notes, written transcripts of interviews and ultimately written scripts. Those written scripts then become the immutable directives for how the stories will ultimately be edited. These written scripts are also a product of the technology of the 1960s that is no longer employed, yet the practice continues. Taking video, which is constructed of pictures and sound, and converting that into written text, which has nothing to do with pictures and sound, and then converting that written text (the script) back into video is not just time consuming, it is inherently detrimental to the medium itself. It waters down the reporting and desiccates the inherent power of the television medium.

Finally, there is the very physical architecture of the newsroom itself. Back when the equipment was heavy, unwieldy, expensive, difficult to operate and limited in numbers, it was essential that the reportorial staff worked out of a studio or an office. That was where all reporters met each morning for a ‘morning meeting’, where the reporters were paired with their camera crews, where the reporters returned after the shoot to write their scripts, where they went into the record booths to track their stories, and where the edits suites, with their dedicated professional editors, sat to “cut” their stories for air.

A studio typically encompasses a lot of real estate and real estate is expensive. As well, the need to commute from home to the studio, from the studio to the story, from the story back to the studio and finally from the studio back home is enormously time consuming. The constraints of the equipment from the early years made it impossible to work in any other way.

Accordingly, there is a long-felt need to modernize the journalistic process by accommodating modern video and computer networking technologies so as to minimize and/or eliminate various historical inefficiencies in the field.

### SUMMARY

This disclosure presents an entirely new way of gathering new stories to pitch, and technological improvements for processing, aggregating and storing that information. Once a pitch has been approved, the systems of the present disclosure radically change the way that journalists interface with their producers and editors, eliminating the need for all paper or text. Additionally, the disclosed systems vastly simplify, streamline and standardizes the flow of content, information and data in the digital media newsroom.

The great transformative event here is the arrival of the smart phone, such as the IPHONE. It is the marriage of the smart phone and the web that provides the potential to completely change the way newsrooms and other analogous facilities operate.

Every reporter, no matter what medium they work in, now carries a smart phone with them all the time. The disclosed improvement is a piece of data managing software that encompasses both a server-based software and an App that sits on the smart phone and allows the reporter to become the singular node of content generation and transmission, replacing the cumbersome and complex systems that newsrooms and the like hitherto employed.

One disclosed embodiment, the Digital News Media Software System (DNMSS), empowers the journalist in the field to aggregate varied and vast potential sources for new story generation in their community or ‘patch.’ It thus removes the need for a traditional assignment desk. The DNMSS App not only connects the single journalist with varied sources of content for possible stories, but it also automatically stores and categorizes potential stories and contacts for future use creating a valuable database.

The DNMSS continually feeds data to the master server, where that data is continually ordinated using artificial intelligence (AI) sorting algorithms and machine learning to provide the network with evolving data on audience preferences as well as reflecting the needs of the viewer and their desire for coverage. Story assignments, the very foundation of every news organizations daily content, is thereby no longer done on an ‘instinctive’ basis, nor in the hands of one person, but rather has true metrics to drive the direction of coverage.

The DNMSS also provides the journalist with a standardized means of pitching the story to the editor, desk or executives who will ‘green light’ the story proposal, thus integrating the work flow process from beginning to end.

DNMSS also provides the journalist with a ‘plug and play’ template for story construction.

Along with streamlining the story pitch and development process, DNMSS also vastly streamlines the hitherto cumbersome script and cut review process, allowing the journalist to send the editor or producer a ‘rough cut’ which can be reviewed by the producer or editor while the journalist is still in the field, allowing for greater control over content and vastly cutting costs. It also eliminates the need for paper scripts.

In aggregate, that is, when all the reporters in a given news organization are using the App in concert, DNMSS allows management to efficiently leverage off the vast potential resources of all cameras and reporters being used in the field. It eliminates the traditional piecemeal method of assignment and completion of assignment that has hitherto dominated the news business. It vastly speeds up the assignment and production process, cutting the costs by a very significant percentage.

DNMSS also allows editorial management to assign and control reporter's time, allowing them to work on multiple stories at the same time. It allows newsrooms to aggregate multiple reporters to cover the same story and coordinate their work and output. It effectively removes the conventional role of the ‘desk’ in terms of assignment of stories, currently the industry standard in every newsroom whether newspaper, radio, TV or web-based media.

DNMSS also allows the employer to continually track the productivity of the reporter in the field. DNMSS creates analytical analyses of metrics such as the shooting ratio between raw footage and footage that makes air, the number of stories produced each week, and the time it takes to produce each story, among others.

Finally, the DNMSS software system allows TV stations, newspapers and the like to grow a massive and highly searchable database of all contacts, story leads, community members, research materials and so on.

### BRIEF DESCRIPTION OF THE DRAWINGS

The following description, given by way of example and not intended to limit the disclosure to the disclosed details is made in conjunction with the accompanying drawings, in which like references denote like or similar elements and parts, and in which:

FIG. 1 is an illustration of a network of sources and outputs employed by the smart phone-based App of the present disclosure;

FIG. 2 is a process flow diagram for aggregating and sorting material using AI and Machine Learning according to the present disclosure;

FIG. 3 is a process flow diagram demonstrating the way in which the App interfaces with the DNMSS server according to the present disclosure;

FIG. 4 is a graphical representation of how the DNMSS works in the field according to the present disclosure;

FIG. 5 is a graphical representation of how the DNMSS allows the Desk to ordinate and coordinate time usage amongst multiple MMJs to maximize output, according to the present disclosure;

FIG. 6 is an illustration of how DNMSS reports performance, productivity and time management of MMJs in the field, according to the present disclosure; and

FIG. 7 is a flow chart that demonstrates how the DNMSS accumulates and aggregates story metrics using AI and machine learning according to the present disclosure.

### DETAILED DESCRIPTION

It is to be understood that the figures and descriptions of the present disclosure have been simplified to illustrate elements that are relevant for a clear understanding of the various implementations, while eliminating for purposes of clarity many other elements that are conventional in this art. Those of ordinary skill in the art will readily recognize that such other elements may be desirable for implementing the presently disclosed systems. However, because they do not necessarily facilitate a better understanding, discussion of such elements is not always provided herein.

Embodiments of the disclosure are described below with reference to the accompany drawings. It is to be understood, however, that the disclosed systems may encompass other embodiments that are readily understood by those of ordinary skill in the art. Also, the disclosure is not limited to the depicted embodiments and the details thereof, which are provided for purposes of illustration and not limitation.

Unless the context requires otherwise, throughout the specification and claims which follow, the word ‘comprise’ and variations thereof, such as “comprises” and “comprising” are to be construed in the open, inclusive sense, that is as “included but not limited to.”

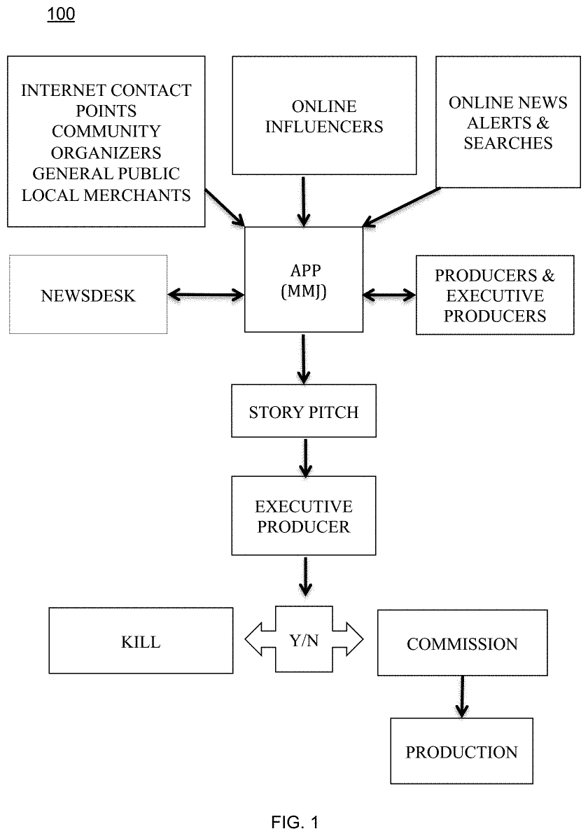

Turning now to FIG. 1, therein is shown the smartphone-based app of the DNMSS that allows MMJs (Multi Media Journalists) reporting from the field 100 to become effective ‘nodes of content’ and story pitches. The App, or more particularly the field application portion of the DNMSS, allows for contact with limitless community sources of news, access to online search functions, contact with the Desk and Producers, as well as messaging between all parties concerned. It allows the MMJ in the field 100 to use aggregated material to create a story ‘Pitch’ that may preferably be template-driven. The pitch is then transmitted to an Executive Producer who can comment, correct, approve or kill any given story idea. The software for the App opens contact with a variety of potential story and information sources in the MMJs' specific ‘beats’ or geographical patches. These include, but are not limited to Community Organizers, The Office of the Mayor or other government officials, and public relations officers for a large variety of organizations, merchants, online influencers as well as the general public.

Those parties or individuals interested in pitching a story to a broadcasting station must go through the field reporter in their community, the MMJ. The App allows communication between those interested parties and the specific MMJ with extensive data protection.

Any party interested in providing a lead to an MMJ through the App will encounter a simple form to fill out which allows the interested party to inform the MMJ of a potential story, including but not limited to location, time, contact information, photos, videos and the like. Such contact may also be done anonymously in the event of a possible whistleblower of a source for an investigative story, whereby various facets (i.e., phone number, or device network address) of the party can be verified by the App but not provided to the MMJ. The MMJ, through a messaging aspect on the App is then free to respond or communicate with the interested party now or in the future.

The App also allows submission of potential stories from the Newsdesk, from the Executive Producer(s), and/or from online news alerts tied to local or national news alerts with a search function.

All of this data, which is typically a constant flow for each MMJ, is continually downloaded from the app to the DNMSS, which, using AI and Machine Learning continually builds a searchable data base of story suggestions. This gives the station/network a constant and continually moving moment to moment finger on the pulse of the community that they are covering.

The MMJ, working in the field 100 and having access to this vast array of potential news stories and sources in their community is now free to construct a limited number of story pitches to be offered to the network via the Executive Producer (EP).

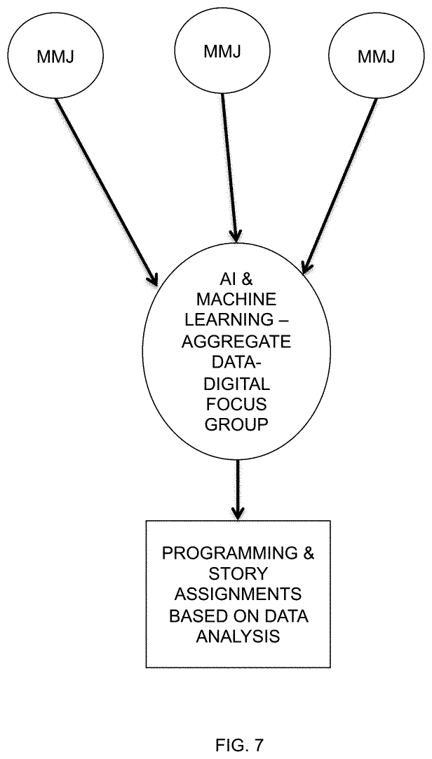

The App may have a self-contained template that allows all story pitches to be quickly turned around in a form that is both quickly comprehensible to the station and makes for easy comparison with other competing pitches. The EP, having access to this information, as well as the continually changing audience research metrics (see, e.g., the discussion below with respect to FIG. 7) is then able to make rapid and informed decisions on which stories to then greenlight for production.

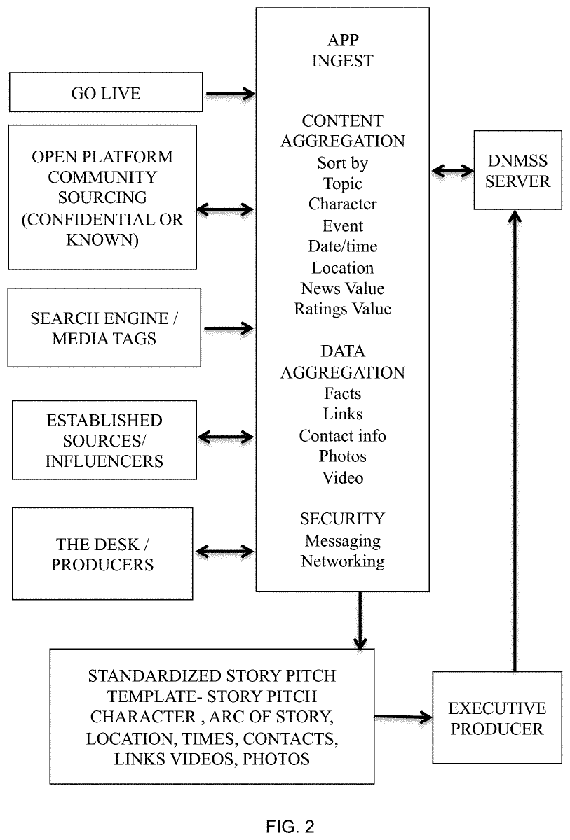

Vast amounts of data are currently lost in the news business at the very early stages of story assignment. The App, among other things, collects it and ordinates it. It is big data of enormous value. The App also creates ongoing analytics on the performance of each reporter, much as a health or diet app might. FIG. 2 illustrates the various components, functions and interactions of the App. Material accumulated on the App in the field by the many MMJs is transmitted to the DNMSS server, which then aggregates and sorts the material using AI and Machine Learning to create a large and rich data base, while at the same time processing the story pitches that are being received. Embodiments of the DNMSS can be practiced in distributed computing environments where tasks or modules are performed by remote processing devices, which are linked through communications networks. In a distributed computing environment, program modules may be located in both local and remote memory storage devices.

A user can enter commands and information into the App or the DNMSS using a variety of input methods. These methods include, for example, a touch screen, a keyboard, a mouse, a camera and/or any other useful input device. According to various embodiments of the present disclosure, one or more of these input devices may be used in order to interact with, edit and create content for the MMJ.

The MMJ is a nexus for submitted story ideas, concepts or even ‘breaking news’ from a limitless multiplicity of connections between the MMJ as the representative of the network and the public who wish to inform or apprise the MMJ of story ideas or breaking news in their community as it happens. Thus, while the public and others are invited to upload story ideas, press releases, personal stories, photos and such to the MMJ, which is processed and passed on to the network for approval and air, the DNMSS also allows the interested party to ‘GO LIVE’ with their video of any event they deem newsworthy directly to the MMJ in the field, either to be tapped as a live report ‘as it happens’ by the network with network approval or to be stored for later editorial use.

The phone-based App aspect of the DNMS is able to ingest but also aggregate and process the vast array of content that will be continually flowing into the app on each individual MMJs phone. The App is able to sort the content by media, topic, character, event, date and time. Location, news value and potential ratings value are assessed and assigned by AI algorithms and the like for each pitch and underlying data associated therewith.

The App also aggregates data, such as facts, links, contact information, and a wide range of media including but not limited to audio, video and text. The app allows direct messaging (DM) to contributors as well as between the Desk, EPs, other contributors, as well as other MMJs.

The App has a high degree of security. The App has a standard Story Pitch Template with plug and play capabilities so that the MMJ can quickly turn around a story pitch to the Desk and the EP for a go/no go decision. All data, media and information acquired by the MMJ on the field app is continually downloaded to the DNMSS server and retained in appropriate databases maintained thereby.

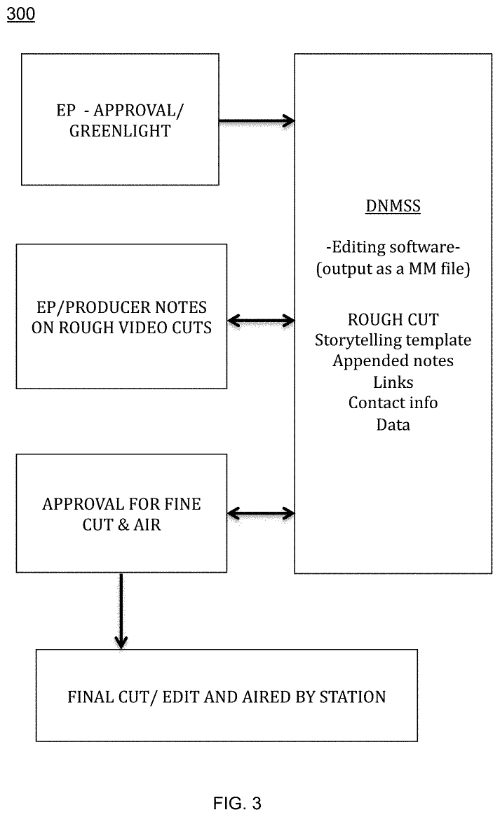

FIG. 3 demonstrates a process 300 by which the App, interfacing with the DNMSS server and the Executive Producer(s) in the studio, can review, approve (green light), correct and fine tune a pitched news piece or the like while the MMJ is still in the field, effectively replacing all traditional paper edits and scripts. FIG. 3 represents the editing/rough cut/editorial and revision and re-shoot functions embodied in the App. In conventional television news businesses, the reporter and crew shoot the raw material of the story, then return to the studio to script it, and then write and edit the story prior to air. There is, in this method, little chance for correction or revision. It is also a process that is entirely paper driven. The DNMSS allows for the complete removal of need to write and use paper to read and make edits to a story. It also allows for management to review and revise cut pieces while the MMJ is still on location, thus allowing for more shooting to correct any errors and omissions in the story.

To accomplish this, the App allows the MMJ to create a rough cut of the story and send it back to the studio via DNMSS whilst still being in the field 100. The App is editing software-agnostic and will interface with any editing software that the smart phone can hold and process. The graphic in FIG. 3 demonstrates the ongoing interface between editorial management in the studio or at the station and the MMJ in the field.

Having shot the story on their smart phone, the MMJ then cuts a very rough assembly of what the story is going to look like, also on their phone. The App contains a storytelling template that the MMJ may use to make the first rough cut of the story.

After having made the rough cut, the DNMSS then allows an interface with the App so that the MMJ can upload the rough cut and share it with the MMJ's editorial manager, most often an assigned EP for the station.

Once received, the DNMSS allows both the MMJ and the EP to simultaneously access both the rough cut and any attendant notes and contact data so that they may review the rough cut of the story together while the MMJ is still on location.

The DNMSS allows for not only text-based notes, but verbal comments as well, to be appended to the story so that the MMJ can then make corrections or resume shooting and/or interviewing until enough material has been acquired to make a suitable finished piece for air.

Upon accommodating any corrections and additions from the foregoing, the MMJ can then move on to final editing, again on their phone (or their tablet device or other computer) to complete the story for air. Again, DNMSS is software agnostic, but interfaces with any and all editing software so as to allow editorial management in the station to continually review fine cuts until a final cut for air is achieved.

The DNMSS does away with the need for the MMJ to ever come to the station, or even need a desk or workspace in the station, thus vastly decreasing the need for expensive extra real estate.

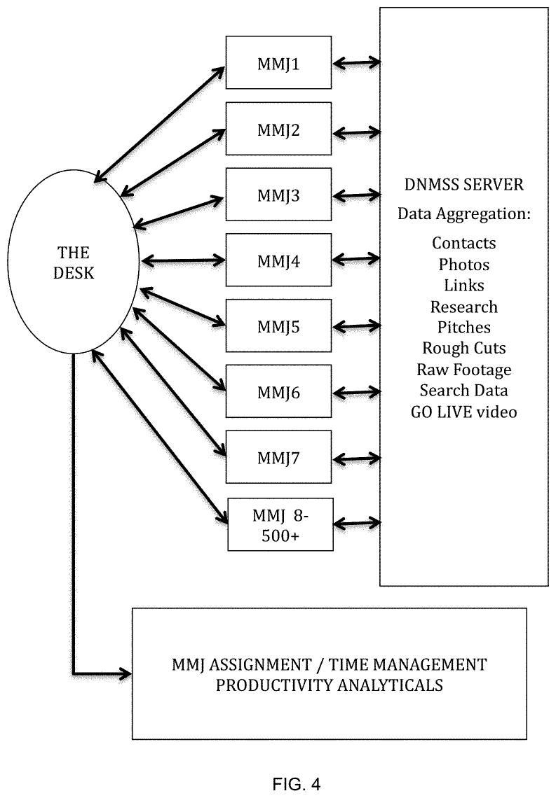

FIG. 4 graphically represents how the DNMSS server works in the aggregate, that is, when multiple MMJs (the standard configuration for any newsroom) are put into the field simultaneously. There is no limit to the number of MMJs that can feed data, story pitches and rough video cuts into the DNMSS system using the App. FIG. 4 also illustrates how the DNMSS monitors and tracks MMJs job performance over time. Heretofore, embodiments have only been described with respect to a sole MMJ using the DNMSS and App in the field. The power of the software, however, is in the aggregate, particularly when all MMJs (and potentially researchers, producers, associate producers, freelancers and everyone else associated with content production) use the software in concert. The DNMSS is designed to coordinate multiple users. As many as 500+ users may be on a specific network's dedicated and protected DNMSS at any given time.

FIG. 4 further represents how the multiple smart phone-based Apps interface with the DNMSS server running the control and processing software. The DNMSS interface allows all of the Apps in the field 100 to continually download content, data, media and so on, as well as communicate with the MMJs in the field 100 directly.

The DNMSS also allows the MMJs to ‘go live’ when the situation warrants, and even accommodate a number of the MMJs to ‘go live’ with a breaking news event, allowing multiple camera coverage at any given time.

FIG. 4 demonstrates how DNMSS manages multiple phones, cameras, data and video feeds and apps simultaneously. The software using AI and Machine learning also aggregates and ordinates all imported video, media files, links, test, contact information and the like, making a searchable and exponentially expandable media database and library, also all accessible via the App to any user at any time for research and story construction.

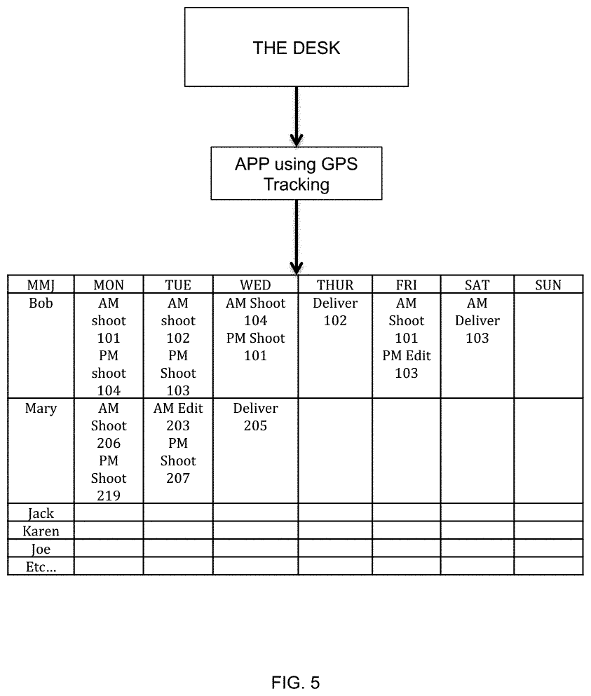

Turning to FIG. 5, therein is a schematic representation of the Desk (which replaces the traditional Assignment Desk in news stations of old) interface with the App and the DNMSS server. In traditional news stations, it was the job of the Assignment Desk to find stories and then to assign them to reporters and their crews. Once the assignment was made, the assignment was carried out in a linear fashion by a reporter and crew. They would depart from the studio, go to the location of the story, shoot the story and return with raw footage. Because the number of cameras and crews were limited due to cost and complexity, the reporter could only have the camera and crew for a limited amount of time. The transition to smart phones that are always with the MMJ means that shooting times and locations, and even the number of MMJs and cameras that can assigned to a specific story, is no longer inherently limited.

Story shooting schedules can be fractionalized, so that parts of a given story can be shot on different days and/or locations and then later be assembled to make one complete piece. By the same token, multiple MMJs can be assigned to work on the same story over a given period of time, so long as delivery deadlines for air are met.

This allows for a far richer story and has the added benefit of making the MMJs working time far more productive. To do this, the traditional function of the Assignment Desk had to change, being now no longer necessary for finding and assigning stories, Instead the Desk uses the DNMSS as the nexus of coordinating where the MMJs are, what they are working on and what their delivery deadlines are. With access to all MMJs via the DNMSS, the Desk now serves the function of traffic manager, both for the physical location of the MMJs at any given time. Global Positioning System (GPS) functions available in most every smart phone helps the Desk locate the MMJS via the App to facilitate more cost-effective assignments and also to coordinate MMJ assignment shooting, editing and delivery schedules.

FIG. 5 is a graphical representation of how the Desk now interfaces both with the DNMSS and the multiple MMJs in the field 100. There is no limit to the number of MMJs that can feed data, story pitches and rough video cuts into the DNMSS system. The graphic also illustrates how the DNMSS monitors and tracks MMJs job performance over time, by reporter and by day.

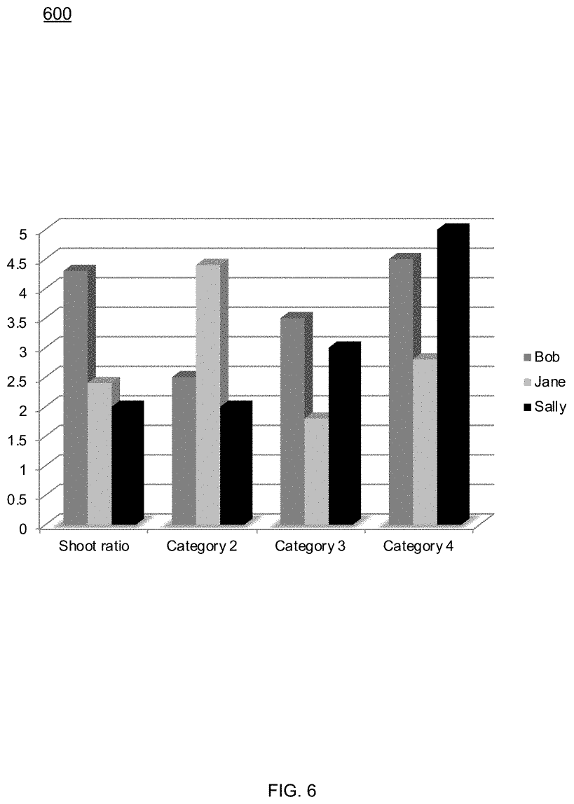

FIG. 6 is an illustration of one way the DNMSS allows the newsroom to continually track the performance, productivity and time management of MMJs working alone and unsupervised in the field by generating performance tracking and analytics. Shown therein is a graphical representation of a report 600 of the performance of individual MMJs (named ‘Bob,’ ‘Jane,’ and ‘Sally’) over, for example, the course of one week's work. The DNMSS system allows management to continually track performance parameters carried out by the MMJs. These parameters are programmable, and thus exponentially expandable, and can include metrics such as shooting ratios (namely, the amount of raw footage shot to the amount of raw footage that makes it into the final air cut of any given story). Currently, the industry standard for shooting ratio is 20:1, meaning the traditional TV news camera person shoots twenty minutes of video for every minute that makes air. This means that stations/networks have historically been throwing away 95% of raw material on every story. This level of waste is intolerable in any other industry and is eliminated by adopting the system herein.

The DNMSS allows the studio or network management to continually track MMJ shooting-to-air ratio and keeps continual score of the ratios, as well as comparing them to other MMJs in the field. A reasonable goal is a 3:1 or better, since the App necessarily helps the MMJ cut down their wastage. Other trackable metrics include number of stories, produced each week, turn-around time for each story, editing time to produce each story, ratings for each story aired and so on.

FIG. 7 demonstrates how the vast amounts of data the MMJs submit using the App are accumulated and aggregated via the DNMSS, which is then used by management to generate extremely precise day to day metrics on what the viewers are interested in. This effectively replaces expensive focus groups as were traditionally employed to make such determination, and has the added benefit of running and updating continually. Quantifying audience interest and engagement with stories using AI and Machine Learning, the DHMSS is constantly assessing the relationship between stories proposed by the community, stories proposed by the Desk and the EP, stories proposed by the MMJ and the attendant ratings that each of those stories achieved once they aired.

Conventional television news stations depends upon amorphous focus groups to give back responses to a wide variety of parameters in the news business, from anchors to reporters, but most significantly to story selection. There are unlimited stories that any given news organization may opt to cover, but it is still largely an unknown as to how audiences respond to those choices. This ‘dark art’ has provided income for companies that engage in audience focus groups—but these are generally largely unreliable. The DNMSS, with its many tentacles and feelers in the community, continuously interconnected by the MMJs and their phones and multiple contacts, represent a massive and ever-growing network that feeds information into the network user.

The DNMSS is thus also an enormous automated audience focus group that is running at every instant, giving the network or station constant feed and data on what the community is actually interested in seeing on their own news broadcasts, as opposed to a single Executive Producer attempting to divine what they believe the audience wants to see. It justifiably puts quantifiable data and numbers in place of the business's traditional use of ‘gut instinct’ to now generate superior and desirable news segments.

Although the best methodologies have been particularly described in the foregoing disclosure, it is to be understood that such descriptions have been provided for purposes of illustration only, and that other variations both in form and in detail can be made thereupon by those skilled in the art without departing from the spirit and scope thereof, which is defined first and foremost by the appended claims.

What is claimed is:

1. An improved communication system, comprising:
a communication device having a microphone for capturing audio data, a camera for capturing image and video data and a global positioning system (GPS) sensor for determining a location of the communication device;
an application stored on the communication device for transmitting the audio data, video data and location data to a management server;
the application further for receiving assignment data, instruction data and approval data from the management server; and
the management server using at least one artificial intelligence algorithm to analyze the audio data, video data and location to generate an approval for the application.

2. The system of claim 1, wherein the communication device is a smart phone.

3. The system of claim 1, wherein the management server uses audience feedback of prior audio and visual data to generate the approval.
